(19) United States
(12) Patent Application Publication
(10) Pub. No.: US 2012/0003532 A1
(43) Pub. Date: Jan. 5, 2012

(54) PROTECTED METAL ANODE ARCHITECTURE AND METHOD OF FORMING THE SAME

(76) Inventors: Michael Edward Badding, Campbell, NY (US); Lin He, Horseheads, NY (US); Lezhi Huang, Shanghai (CN); Yu Liu, Shanghai (CN); Zhaoyin Wen, Shanghai (CN); Meifen Wu, Shanghai (CN)

(21) Appl. No.: 13/176,299

(22) Filed: Jul. 5, 2011

(30) Foreign Application Priority Data
Jul. 5, 2010 (CN) 201010223498.X

(51) Int. Cl. H01M 4/60; C25D 9/02; B05D 5/12; C23C 8/24; H01M 4/40; H01M 4/58

(52) U.S. Cl. 429/215; 427/58; 148/238; 205/317

(57) ABSTRACT

The invention provides a protected metal anode architecture comprising: a metal anode layer; and an organic protection film formed over and optionally in direct contact with the metal anode layer, wherein the metal anode layer comprises a metal selected from the group consisting of an alkaline metal and an alkaline earth metal, and the organic protection film comprises a reaction product of the metal and an electron donor compound. The invention further provides a method of forming a protected metal anode architecture.

### CROSS-REFERENCE TO RELATED APPLICATIONS

This application claims the benefit of priority under 35 U.S.C. §119 of Chinese Patent Application Serial No. 201010223498.X, filed on Jul. 5, 2010, the content of which is relied upon and incorporated herein by reference in its entirety.

### TECHNICAL FIELD

The invention relates to the field of chemical electric power source, particularly, relating to a protected metal anode architecture and method of forming the same.

### BACKGROUND OF THE ART

As the volume and weight of various multi-functional portable electronic products such as video camera, video recorder, mobile phone and portable PC are decreasing, the requirement on the properties of rechargeable secondary batteries for use in these electronic products becomes higher and higher. The development of rechargeable secondary batteries having high specific energy has become the current research focus. Correspondingly, for electrode materials, the requirement on them not only lies in high specific energy of weight to volume, but also lies in high ion/electron conductivity, high oxidization/reduction reversibility, good thermal chemical stability within the scope of application, low cost, etc.

In theory, alkali metals are those materials having great potential for anode of rechargeable secondary batteries, wherein the use of lithium metal as the anode of the battery having high specific energy calls great attention. ([1] N. Munichandraiah, L. G. Scanlon, R. A. Marsh, J. Power Sources 72 (1998) 203-210; [2] J. I. Yamaki, S. I. Tobishima, in: J. O. Besenhard (Ed.), HandBook of Battery Materials, Wiley-VCH, New York, 1999, pp. 339-357; [3] H. Ota, Y. Sakata, Yamaki, J. Electrochem. Soc. 151 (2004) A1778.)

However, unfortunately, up to the present, there is no successful commercial application of rechargeable secondary lithium metal batteries, and the main limit thereof is poor safety and circulation property of batteries. ([4] E. Pled, J. Electrochem. Soc. 126 (1979) 2047; [5] R. D. Rauch, S. B. Brummer, Electrochim. Acta 22 (1977), 75; [6] S. Tobishima, M. Arakawa, H. Hirai, J. Yamaki, J. Power Sources 26 (1989) 449.) Since the “lithium dendritic crystal” may be formed on the metal lithium anode surface during the circulation of secondary lithium metal batteries, as the times of circulation increase, the “lithium dendritic crystal” (lithium dendrites) grows sharply through electrolyte to contact with cathode, causing short circuit within the battery and that the battery fails at last; and, meanwhile, since the “lithium dendritic crystal” on the lithium metal surface is easily soluble in the electrolyte to form “dead lithium”, it loses contact with electron so that the electrochemical reaction cannot be conducted. The formation of “dead lithium” lowers the circulation efficiency of metal lithium in one aspect, and in the other aspect, since the “dead lithium” having high activity residues in the electrolyte so as easily to conduct side reactions with the electrolyte, thus the safety of the battery is threatened. ([7] S. B. Brummer, V. R. Koch, in: D. W. Murphy, J. Broadhead, B. C. H. Steel (Eds.), Materials for Advanced Batteries, Plenum, New York, 1980, pp. 123-143; [8] J. I. Yamaki, S. I. Tobishima, Y. Sakurai, K. I. Saito, J. Hayashi, J. Appl. Electrochem. 28 (1997) 135-140.)

To inhibit the growth of dendritic crystal, and improve circulation efficiency of lithium within liquid electrolyte system, generally, various inorganic, organic and physical methods are used to modify metal lithium anode so as to form a layer of effective protective film on the lithium anode surface to prevent direct contact between lithium anode and electrolyte.

The inorganic modification includes forming a protective film on lithium anode surface in situ, and sandwiching an inorganic separation membrane between lithium anode and electrolyte. The former is mainly formed by the chemical reaction or electrochemical reaction between metal lithium and additive in the electrolyte, such as the addition of CO₂ ([9] Hong Gan and Esther S. Takeuchi, Journal of Power Sources 62 (1996) 45), N₂O ([10] J. O. Besenhard, M. W. Wagner, M. Winter, A. D, J. Power Sources 44 (1993) 413), HF (([11] K. Kanamura, S. Shiraishi, Z. Takehara, J. Electrochem. Soc. 141 (1994) L108; [12] K. Kanamura, S. Shiraishi, Z. Takehara, J. Electrochem. Soc. 143 (1996) 2187; [13] S. Shiraishi, K. Kanamura, Z. Takehara, Langmuir 13 (1997) 3542; [14] Z. Takehara, J. Power Sources 68 (1997) 82), AlI₃, SnI₂ ([15]Y. S. Fung and H. C. Lal, J. Appl. Electrochem. 22 (1992) 255; [16] J. O. Besenhard, J. Yangm, M. Winter, J. Power Sources 68 (1997) 87; [17] M. Ishikawa, M. Morita, Y. Matsuda, J. Power Sources 68 (1997) 501), MgI₂ ([18] C R CHAKRAVORTY, Bull. Mater. Sci., 17 (1994) 733; [19] Masashi Ishikawa, et al, Journal of Electroanalytical Chemistry, 473 (1999) 279; [20] Masashi Ishikawa, et al. Journal of Power Sources 146 (2005) 199-203.)

However, such a film generally has porous morphology, through which the electrolyte can penetrate, so that the complete protection effect cannot be realized. The latter is mainly formed by directly forming on lithium surface a protection film of various lithium ions by various physical methods such as sputtering C₆₀ ([21] A. A. Arie, J. O. Song, B. W. Cho, J. K. Lee, J Electroceram 10 (2008) 1007), LiPON, LiSCON ([22] Bates. et. al U.S. Pat. Nos. 5,314,765 1994 May; 5,338,625 1994 August; 5,512,147 1996 April; 5,567,210 1996 October; 5,597,660 1997 January; [23] Chu. et. al U.S. Pat. No. 6,723,140B2 2004 April; [24] Visco. et. al U.S. Pat. Nos. 6,025,094 2000 February; 7,432,017B2 2008 October; [25] De Jonghe L, Visco S J, et al. US2008113261-A1). However, the preparation process conditions for these films are rather strict, and the preparation cost is also high, thus detrimental to large area preparation or commercial application.

The organic modification methods mainly include: (a) directly covering a protection layer on lithium anode surface, such as poly 2-ethylenepyridine and poly 2-ethylene oxide (PEO) ([26] C. Liebenow, K. Luhder, J. Appl. Electrochem. 26 (1996) 689; [27] J. S. Sakamoto, F. Wudl, B. Dunn, Solid State Ionics 144 (2001) 295), polyvinyl pyridine polymer, two vinyl pyridine polymer ([28]Mead et. al. U.S. Pat. No. 3,957,533 1976 May; [29] N. J. Dudneyr, J. Power Sources 89 (2000) 176. et. al.); (b) forming a layer of protection film by reacting metal and some organic additives in situ, such as 2-methyl furan, 2-methyl thiophene ([15] M. Morita J. Ekctrochimica Acta 31 (1992) 119), quinone compound dye ([16] Shin-Ichi Tobishim, Takeshi Okada, J. of Appl. Electrochem. 15 (1985) 901) and vinylene carbonate ([17] Hitoshi Ota. et. al J. Electrochimica Acta 49 (2004) 565), the defects of which are similar to those of the inorganic modification as mentioned above.

The physical modification includes, for example, treating lithium anode under different pressures or treating electrolyte under different temperatures ([33] Toshiro Hirai, et al. J Electrochem. Soc. 141 (1994) 611; [34] Masashi Ishikawa, et al. Journal of Power Sources 81-82 (1999) 217), the preparation process of which is rather complex.

As seen from the surface modification effects of metal lithium mentioned above, the above problems cannot be completely solved yet. Currently, the method of using inorganic and organic complex modification on lithium anode is rarely reported.

Meanwhile, preparing lithium electrode having a protection layer, whether on-line in situ or off-line, it is required that only the metal lithium surface is smooth and clean, can the protection layer be deposited. However, most commercially obtained lithium electrode has a rough surface and cannot form uniform and zero-defect protection film.

Furthermore, since the metal lithium has high activity, it is required that the preparation of metal lithium electrode is performed in the conditions of O₂-free, CO₂-free, vapor-free and N₂-free, so the process difficulty and cost are rather high.

Summing up the above, the key point and hot point of developing secondary lithium batteries having high specific capacity are to search effective protecting technology for metal lithium anode.

### SUMMARY OF THE INVENTION

The first object of the present invention is to obtain a new surface protection structure for metal lithium, which is used to solve the problems such as the growth of lithium “dendritic crystal” for metal lithium anode material during circulation, and lower circulation efficiency.

The second object of the present invention is to obtain a new method for protecting metal lithium surface, which is used to solve the problems such as the growth of lithium “dendritic crystal” for metal lithium anode material during circulation, and lower circulation efficiency.

In one aspect of the present invention, there is provided a protected metal anode architecture comprising:

a metal anode layer; and

an organic protection film formed over and optionally in direct contact with the metal anode layer, wherein

the metal anode layer comprises a metal selected from the group consisting of an alkaline metal and an alkaline earth metal, and

the organic protection film comprises a reaction product of the metal and an electron donor compound.

Preferably, the organic protection film is formed over the metal anode layer directly.

In one specific embodiment of the present invention, the metal anode layer comprises a lithium metal or a lithium metal alloy.

In one specific embodiment of the present invention, the metal anode layer comprises a lithium metal and the organic protection film comprises lithium pyrrolide.

In one specific embodiment of the present invention, the organic protection film comprises one or more of an alkylated pyrrolide, phenyl pyrrolide, alkenyl pyrrolide, hydroxy pyrrolide, carbonyl pyrrolide, carboxyl pyrrolide, nitrosylated pyrrolide and acyl pyrrolide.

In one specific embodiment of the present invention, the electron donor compound is selected from the group consisting of pyrrole, indole, carbazole, 2-acetylpyrrole, 2,5-dimethylpyrrole and thiophene.

In one specific embodiment of the present invention, the organic protection film has an average thickness of no more than 200 nm.

In one specific embodiment of the present invention, the electron donor compound has an average density of from about 20 to 95% of a theoretical density of the organic protection film.

In one specific embodiment of the present invention, the electron donor compound comprises one or more inactive additives selected from the group consisting of tetrahydrofuran, di-methyl ether, di-methyl sulfide, acetone and diethyl ketone.

In one preferred example, the anode surface is needed to be pre-treated by the inactive additives, and the inactive additive is just the electron donor compound.

In one specific embodiment of the present invention, the electron donor compound is in direct contact with the metal anode layer.

In one specific embodiment of the present invention, the protected metal anode architecture further comprises an inorganic layer formed between the metal anode layer and the organic protection film.

In one specific embodiment of the present invention, the inorganic layer comprises a nitride of the metal.

In another aspect of the present invention, there is provided a method of forming a protected metal anode architecture comprising:

optionally pre-treating an exposed surface of a metal anode;

exposing the metal anode to a solution comprising an electron donor compound; and

forming an organic protection film over the metal anode layer, wherein the organic protection film comprises a reaction product of the metal and the electron donor compound.

In one specific embodiment of the present invention, the pre-treating comprises exposing the metal anode to a solution comprising one or more inactive additives selected from the group consisting of tetrahydrofuran, di-methyl ether, di-methyl sulfide, acetone and diethyl ketone.

In one specific embodiment of the present invention, the pre-treating comprises forming a metal nitride layer over a surface of the metal anode.

In one specific embodiment of the present invention, the pre-treating comprises exposing a surface of the metal anode to flowing nitrogen and forming a metal nitride layer over a surface of the metal anode.

In one specific embodiment of the present invention, the electron donor compound is selected from the group consisting of pyrrole, indole, carbazole, 2-acetylpyrrole, 2,5-dimethylpyrrole and thiophene.

In one specific embodiment of the present invention, a concentration of the electron donor compound in the solution ranges from about 0.005 to 10M.

In one specific embodiment of the present invention, a concentration of the electron donor compound in the solution ranges from about 0.01 to 1M.

In one specific embodiment of the present invention, the reaction product is formed by applying a current density of from about 0.1 to 5 mA/cm² and a charge potential of from about 1 to 2V between the metal anode layer and a second electrode.

In one specific embodiment of the present invention, the reaction product is formed by applying a current density of from about 1 to 2 mA/cm² and a charge potential of from about 1 to 2V between the metal anode layer and a second electrode.

Preferably, the second electrode is a counter electrode. More preferably, the reaction product is formed by the counter electrode, and the counter electrode refers to metal or alloy which is inert to the metal or metal ion, including Cu, Ni and stainless steel.

### BRIEF DESCRIPTION OF THE DRAWINGS

FIG. 1 is a schematic view showing the preparation of lithium anode material which is multiple-coated by Li₃N and pyrrole.

FIG. 2 is a curve showing the relationship between the electrochemical impedance of Li—Li₃N/LiPF₆+EC+DMC/Li—Li₃N vs. time in Example 2.

FIG. 3 is a curve showing the relationship between the electrochemical impedance of Li—Li₃N(Pyrrole+THF (1:1 v/v))/LiPF₆+EC+DMC/Li—Li₃N(Pyrrole+THF (1:1 v/v)) vs. time in Example 5.

FIG. 4 shows the change of Coulombic efficiency of Cu/LiPF₆+EC+DMC/Li—Li₃N battery when circulating 20 times.

FIG. 5 shows the change of Coulombic efficiency of Cu/LiPF₆+EC+DMC/Li—Li₃N(Pyrrole+THF (1:1 v/v)) battery when circulating 20 times.

FIG. 6 shows the SEM of the deposited lithium for Cu/LiPF₆+EC+DMC/Li—Li₃N battery when circulating 20 times.

FIG. 7 shows the SEM of the deposited lithium for Cu/LiPF₆+EC+DMC/Li—Li₃N(Pyrrole+THF (1:1 v/v)) battery when circulating 20 times.

FIG. 8 is a curve showing the relationship between the electrochemical impedance of Li/LiPF₆+EC+DMC/Li vs. time.

FIG. 9 is a curve showing the relationship between the electrochemical impedance of Li/Pyrrole(0.1M)+LiPF₆+EC+DMC/Li vs. time in Example 8.

FIG. 10 shows cycle VA curve for Cu/LiPF₆+EC+DMC/Li.

FIG. 11 shows cycle VA curve for Cu/Pyrrole(0.1M)+LiPF₆+EC+DMC/Li in Example 9.

FIG. 12 shows the SEM of the deposited lithium for Cu/LiPF₆+EC+DMC/Li battery when circulating 20 times.

FIG. 13 shows the SEM of the deposited lithium for Cu/Pyrrole(0.1M)+LiPF₆+EC+DMC/Li battery when circulating 20 times in Example 9.

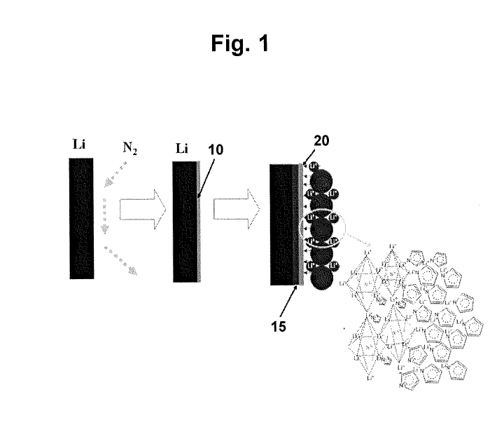

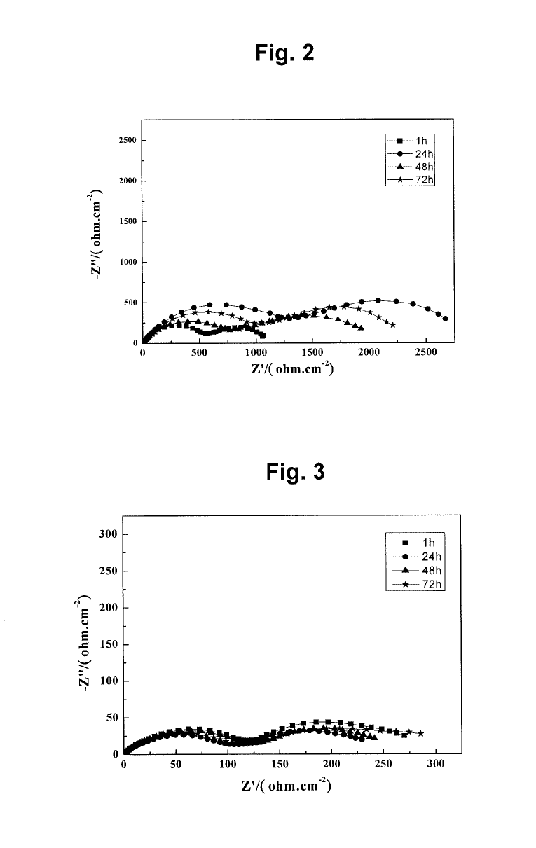

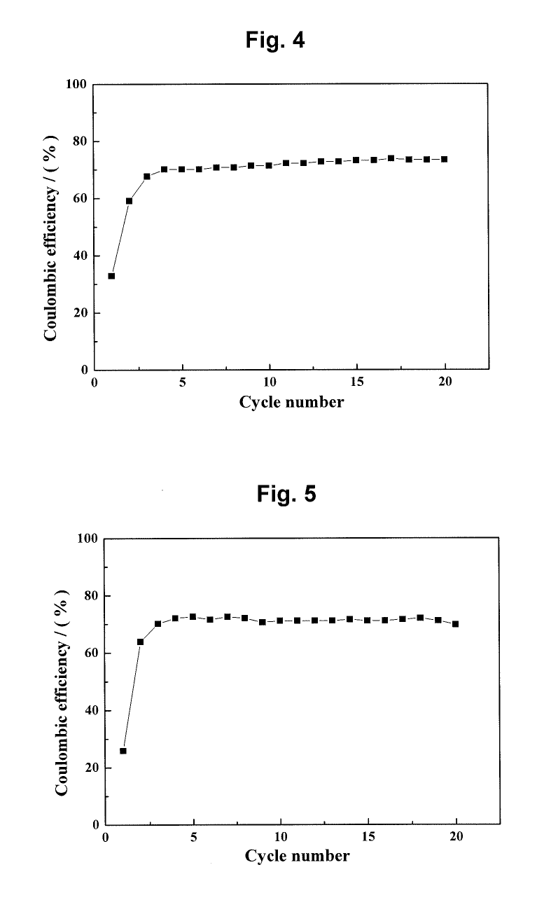

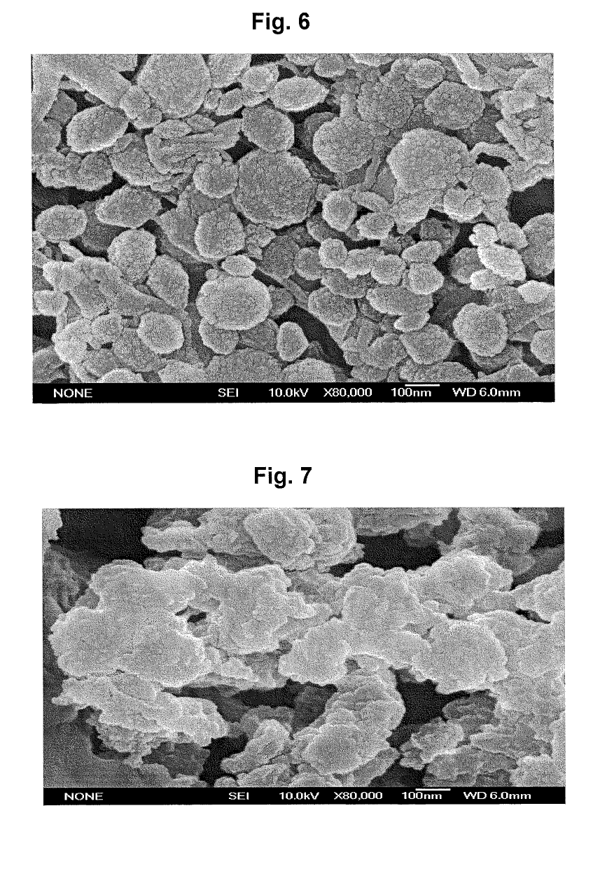

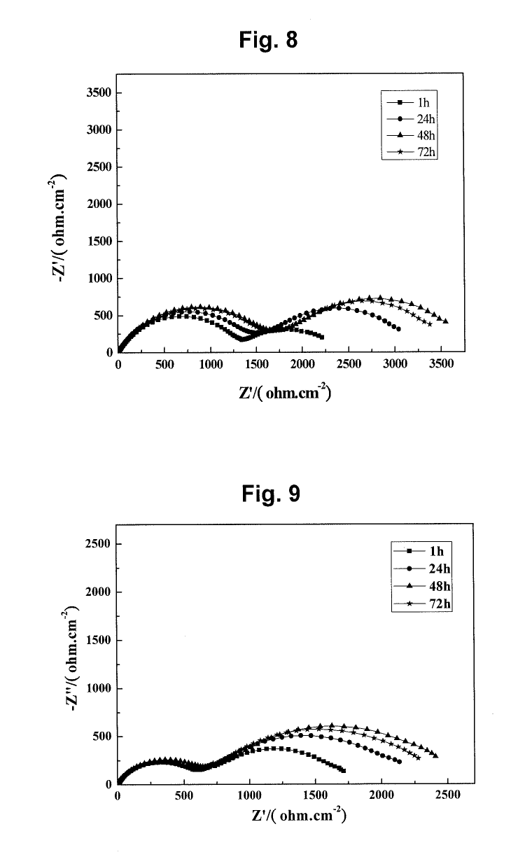

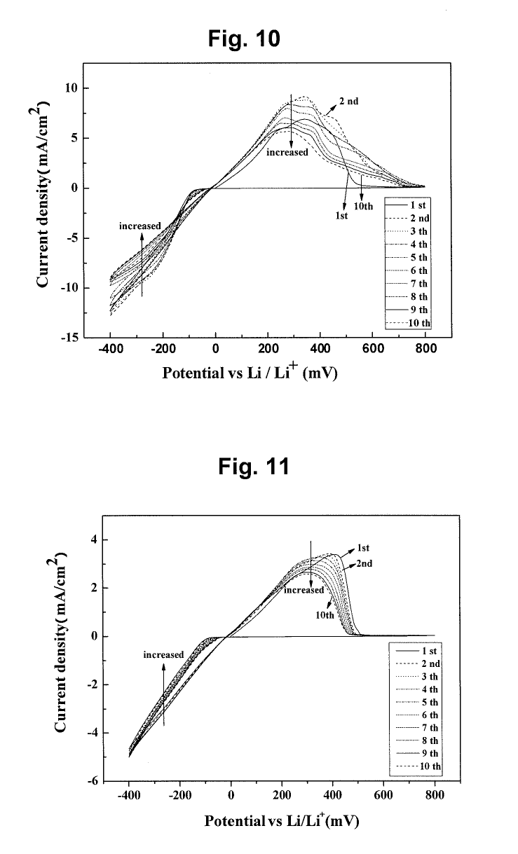

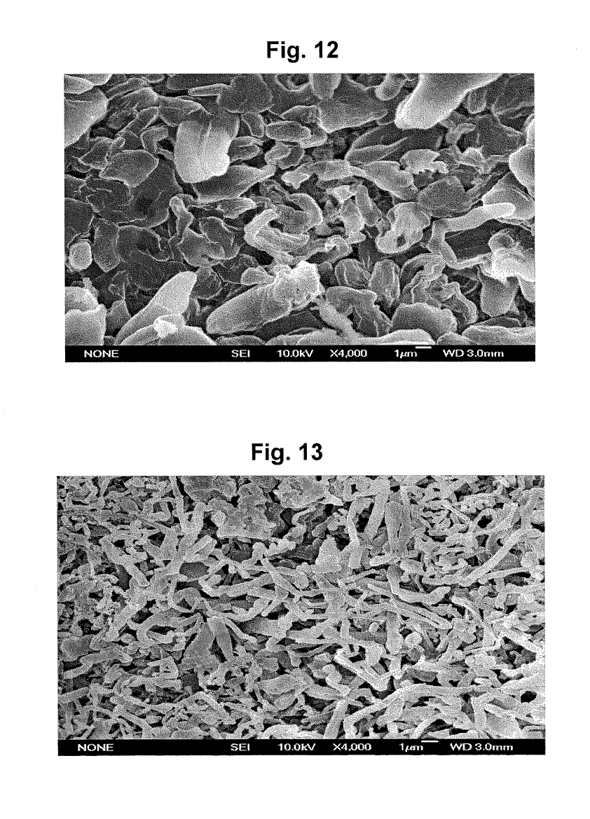

### DETAILED DESCRIPTION OF THE INVENTION

After extensive and intensive study, the present inventors have obtained a new surface protection structure for metal lithium by improving the preparation process, thus solving the problems such as the growth of lithium “dendritic crystal” for metal lithium anode material during circulation, and lower circulation efficiency. The invention is accomplished on the basis of the foregoing findings.

Now, the applicant detailedly illustrates various aspects of the present invention.

### Protected Metal Anode Architecture and Method of Forming the Same

The protected metal anode architecture of the present invention comprises:

a metal anode layer; and

an organic protection film formed over and optionally in direct contact with the metal anode layer, wherein

the metal anode layer comprises a metal selected from the group consisting of an alkaline metal and an alkaline earth metal, and

the organic protection film comprises a reaction product of the metal and an electron donor compound.

The metal anode of the present invention is not limited to metal lithium material, which can be other alkali metal or alkaline earth metal anode material (for example, Na, K and Mg), or lithium alloy material (for example, Li—Sn, Li—Al and Li—Si).

In one specific embodiment of the present invention, the metal anode layer comprises a lithium metal or a lithium metal alloy.

The lithium anode material of the present invention can also be alkali metal or alkaline earth metal anode material (for example, Na, K and Mg), or lithium alloy material (for example, Li—Sn, Li—Al and Li—Si).

In one specific embodiment of the present invention, the metal anode layer comprises a lithium metal and the organic protection film comprises lithium pyrrolide.

In one specific embodiment of the present invention, the organic protection film comprises one or more of an alkylated pyrrolide, phenyl pyrrolide, alkenyl pyrrolide, hydroxy pyrrolide, carbonyl pyrrolide, carboxyl pyrrolide, nitrosylated pyrrolide and acyl pyrrolide.

In the present invention, the material for the protection layer is pyrrole, which has the following two features: (i) used as an electron donor compound, and forming a protection layer on anode surface of metal lithium by physical adsorption; and (ii) obtaining a layer of protection film by chemical reaction with metal lithium. The material for the protection film can also be a electron donor compound, such as indole, carbazole, 2-acetylpyrrole, 2,5-dimethylpyrrole and thiophene.

In one specific embodiment of the present invention, the electron donor compound is selected from the group consisting of pyrrole, indole, carbazole, 2-acetylpyrrole, 2,5-dimethylpyrrole and thiophene.

In one specific embodiment of the present invention, the organic protection film has an average thickness of no more than 200 nm.

In one specific embodiment of the present invention, the electron donor compound has an average density of from about 20 to 95% of a theoretical density of the organic protection film.

In one specific embodiment of the present invention, the electron donor compound comprises one or more inactive additives selected from the group consisting of tetrahydrofuran, di-methyl ether, di-methyl sulfide, acetone and diethyl ketone.

In one specific embodiment of the present invention, the electron donor compound is in direct contact with the metal anode layer.

In one specific embodiment of the present invention, the protected metal anode architecture further comprises an inorganic layer formed between the metal anode layer and the organic protection film.

In one specific embodiment of the present invention, the inorganic layer comprises a nitride of the metal.

The method of forming a protected metal anode architecture comprising:

optionally pre-treating an exposed surface of a metal anode;

exposing the metal anode to a solution comprising an electron donor compound; and

forming an organic protection film over the metal anode layer, wherein the organic protection film comprises a reaction product of the metal and the electron donor compound.

In one specific embodiment of the present invention, the pre-treating comprises exposing the metal anode to a solution comprising one or more inactive additives selected from the group consisting of tetrahydrofuran, di-methyl ether, di-methyl sulfide, acetone and diethyl ketone.

In one specific embodiment of the present invention, the pre-treating comprises forming a metal nitride layer over a surface of the metal anode.

In one specific embodiment of the present invention, the pre-treating comprises exposing a surface of the metal anode to flowing nitrogen and forming a metal nitride layer over a surface of the metal anode.

In one specific embodiment of the present invention, the electron donor compound is selected from the group consisting of pyrrole, indole, carbazole, 2-acetylpyrrole, 2,5-dimethylpyrrole and thiophene.

In one specific embodiment of the present invention, a concentration of the electron donor compound in the solution ranges from about 0.005 to 10M.

In one specific embodiment of the present invention, the reaction product is formed by applying a current density of from about 0.1 to 5 mA/cm² and a charge potential of from about 1 to 2V between the metal anode layer and a counter electrode. The second electrode is inert to the metal and metal ions. More preferably, the reaction product is formed by applying a current density of from about 1 to 2 mA/cm² and a charge potential of from about 1 to 2V between the metal anode layer and a second electrode.

### Preferred Embodiment 1

The present invention provides a preferred embodiment, wherein the protection layer is obtained by directly reacting metal lithium with pyrrole in chemical or electrochemical process.

To avoid the production of H₂, the reaction process is optimally conducted in neutral or basic (pH≧7) condition.

The surface of the lithium metal is preferably washed by tetrahydrofuran, so as to avoid the production of H₂ and stabilize pyrrole anion. Such a washing agent can also be other non-active organic compounds such as non-polar ethers (dimethyl ether, dimethyl thioether, etc.) and ketones (acetone, diethyl ketone, etc.).

The inactive additives of the present invention can be pre-treated alone, or added together with pyrrole into electrolyte to treat metal lithium surface. For example, tetrahydrofuran (THF) can be pre-treated alone, or added together with pyrrole in a volume ratio of 1:10 (V_{THF}/V_{pyrrole}) into electrolyte to treat metal lithium surface.

The protection film of the present invention is a self-assembly film, because pyrrole anion has high selectivity for lithium ion, which not only has great ability to capture lithium ion, but also has great ability to reject other solvent components or impurities.

The thickness of the protection film in the present invention depends on the concentration of pyrrole. The higher the concentration, the thicker the film. Generally, the thickness is no more than 200 nm.

The thicker the protection film, the lower the interface impedance of the lithium vs. electrolyte, as well as the circulation efficiency. To keep low interface impedance as well as high circulation efficiency, the proper concentration of pyrrole ranges 0.005M-10M, wherein the optimal concentration is 0.01±0.001M.

The density of the protection film in the present invention is ≧60%.

The protection film in the present invention can be obtained by chemical process non-in situ or electrochemical process in situ.

The proper temperature for preparing the protection film non-in situ or in situ can be −20° C. to 60° C., wherein the optimal temperature is 25±1° C.

As to the thickness of the protection film obtained in the chemical process non-in situ, the thickness of the protection layer in the present invention also depends on the reaction time between metal lithium and pyrrole, in addition to the concentration of pyrrole, wherein the optimal reaction time for all concentrations is 2-3 min. As to the thickness of the protection film obtained in the electrochemical process in situ, it also depends on current density and charging voltage, wherein the optimal current density ranges from 0.5 mA/cm² to 2 mA/cm², and the optimal charging voltage ranges from 1V to 2V.

The specific embodiment of the invention is as follows:

A. The Preparation of Lithium Anode Material Coated by Pyrrole and the Characterization of the Electrochemical Properties.
(1) formulating a mixed solution of pyrrole (0.005-10M) and electrolyte (for example, 1M LiPF₆/(EC+DMC) (w/w 1:1)) according to stoichiometric ratio at the light shielded place;
(2) in inert atmosphere or vacuum environment, using pre-fabricated two pieces of fresh lithium foils with Φ 14 mm and thickness of 1-2 mm as electrodes, the mixed solution in above (1) as electrolyte, and polypropylene film obtained from Celgard (US) as a separation film to assemble 2025 button battery; and after standing for 1-72 h, conducting tests for electrochemical alternating current impedance for different time; and
(3) in inert atmosphere or vacuum environment, using the same conditions as those of (2) except using pre-mirror polished Cu piece electrode with Φ 14 mm and thickness of 1-2 mm as working electrode to assemble battery; and after standing for 24 h, conducting cycle CV test and constant current charging and discharging cycle test.

B. The Morphology Characterization of the Product.
The Li deposited morphology after the constant current charging and discharging cycle test is observed by field emission scanning electron microscope (SEM). The obtained lithium anode coated by pyrrole shows lower and more stable interface resistance, and the metal lithium uniformly deposits in the form of fiber.

The inventor of the present invention has found, the problems such as the growth of lithium “dendritic crystal” of metal lithium anode material during circulation and lower circulation efficiency can be solved by reacting lithium and pyrrole in electrolyte in chemical or electrochemical process to form a layer of pyrrolized organic lithium protection film. Such a protection film is a self-assembly film having high electron conductivity and a certain lithium ion conductivity, which can not only significantly lower lithium vs. electrolyte interface impedance, but also make the interface more stable. Meanwhile, since such a film is not sensitive to water and air, and pyrrole anion has high selectivity on lithium ion, the adverse reaction between metal lithium and electrolyte can be avoided.

### Preferred Embodiment 2

The present invention also provides a more preferred embodiment, i.e. the pre-treating comprises forming a metal nitride layer over a surface of the metal anode.

The material for internal protection film in the present invention is lithium nitride, which has the following two features: (i) being an inorganic compound having highest lithium ion conductivity (10⁻³S/m); and (ii) having good compatibility with metal lithium anode, and having strong rejection effect on organic electrolyte component, thus effectively reducing the adverse reaction between metal lithium and electrolyte component or impurities. And, these two features also make Li—Li₃N be applied in more different kinds of organic electrolytes, and inhibit the growth of “dendritic crystal”. These protection film materials can be also be other mono lithium ion conductors such as LiPON, LiSON and Li₃P.

Preferably, the internal protection film materials in the present invention, i.e. lithium nitride, is prepared by using a gas-solid reaction method. Such a method can provide more active sites to conduct lithium ion, so as to significantly lower lithium vs. electrolyte interface impedance.

The external pyrrole protection film in the present invention is very important due to the facts that in one aspect, it is not sensitive to water and air, and in another aspect, it can effectively protect Li₃N so as to avoid its decomposition caused by trace water in electrolyte. And, such a two-layer protection film can not only avoid the change of the lithium vs. electrolyte interface impedance as the time passes, but also improve the cycle life of battery.

To stabilize pyrrole anion, the present invention adds tetrahydrofuran. Preferably, the use of tetrahydrofuran is as follows: (a) directly pre-treating metal lithium anode surface; and (b) mixing with pyrrole and then treating Li—Li₃N surface. Such an inactive additive can be also other polar ethers such as dimethyl ether, 2-methyl tetrahydrofuran and 1,2-dioxane.

Preferably, the proper mixing ratio of the inactive additive to pyrrole in the present invention ranges from 1 to 20 (volume ratio), for example, V_{THF}/V_{pyrrole}=1-10.

The internal Li₃N protection film in the present invention can be prepared by directly introducing N₂ into one side of lithium anode during chemical or electrochemical process. The thickness of Li₃N film depends on reaction time and N₂ flow rate. The optimal film thickness is 100-200 nm, the optimal reaction time is 1-5 hours and the optimal flow rate is 0.1-1 L/s. And, the proper reaction temperature is −20° C. to 60° C., and the optimal temperature is 25±1° C. The preparation thereof can be also be extended to directly reacting metal lithium with metal nitrides, such as Cu₃N, Ca₃N₂, Fe₃N and CO₃N.

The external protection film in the present invention can be prepared during chemical or electrochemical process. In chemical process, the proper time for post-treating Li—Li₃N anode surface by using a mixed solution of pyrrole and THF is 1-3 minutes. One specific embodiment of the present invention is as follows:

A. The Preparation of Lithium Anode Material Coated by Li₃N Inorganic Film and Pyrrole Organic Film and the Characterization of the Electric Properties.
(1) sealing one side of lithium tape in inert atmosphere or vacuum environment, then placing it into a vacuum drier, and then introducing a certain amount of N₂ into the drier wherein the flow rate of N₂ is 0.1-1 L/s and the time is 1-5 h;
(2) in inert atmosphere or vacuum environment, preparing the lithium tape into a disc electrode for use wherein the diameter is 14 mm and the thickness is 1-2 mm;
(3) formulating a mixed solution of pyrrole (0.1-1M) and tetrahydrofuran according to stoichiometric ratio at the light shielded place, and immersing the lithium piece prepared in (2) the mixed solution for 1-3 min;
(4) in inert atmosphere or vacuum environment, using filter paper to dry the lithium piece prepared in (3) so as to be used as electrode, using 1M LiPF₆/EC+DMC (1:1 w/w) as electrolyte, and using polypropylene film obtained from Celgard (US) as a separation film to assemble 2025 button battery; and after standing for 1-72 h, conducting tests for electrochemical alternating current impedance for different time; and
(5) in inert atmosphere or vacuum environment, using the same conditions as those of (4) except using pre-mirror polished Cu piece electrode with Φ 14 mm and thickness of 1-2 mm as working electrode to assemble battery; and after standing for 24 h, conducting cycle CV test and constant current charging and discharging cycle test.

B. The Morphology Characterization of the Product.
The Li deposited morphology after the constant current charging and discharging cycle test is observed by field emission scanning electron microscope (SEM). After test, the obtained lithium anode coated by composite film shows lower and more stable interface resistance, while keeping high circulation efficiency.

The inventor of the present invention has found metal lithium electrode materials having a novel inorganic organic composite protection layer and the preparation method thereof, i.e. coating two-layer protection film on lithium electrode surface wherein the internal layer is a Li₃N film formed by reacting lithium and N₂, and external layer is an organic pyrrole protection film formed by treating lithium surface using pyrrole+furan mixed solution. Lithium nitride has special crystal structure and has two layers, wherein one layer is Li₂N⁻ in which the lithium atom is hexa coordinated; and the other layer has lithium ion only. And, pyrrole anion has high selectivity for lithium ion, and has great ability to capture lithium ion, therefore, two layers of protection films are organically combined together by strong static electrification of lithium ion. Thus, lithium nitride inorganic film formed in the internal layer not only has good compatibility with lithium metal anode, but also has strong repelling ability on organic electrolyte, thus effectively preventing metal lithium from being etched by electrolyte. Since the organic pyrrole film in the external layer is not sensitive to water and air, it can prevent Li₃N from decomposition caused by trace water in electrolyte, and can keep good compatibility with outside electrolyte environment. Such a two-layer protection film can not only improve stability of the lithium vs. electrolyte interface, but also improve the cycle life of battery. Such a Li—Li₃N anode prepared by directly introducing N₂ into one side of lithium during chemical or electrochemical process at a room temperature, as compared with that prepared by burning metal lithium in N₂ atmosphere or melting metal lithium in metal Na and then introducing N₂, or that prepared by using liquid metal lithium as ball mill media in pure N₂ atmosphere at 600° C. to melt Li₃N by ball mill, has characteristics of simple preparation process and low cost. Such a Li—Li₃N alloy prepared by gas-solid reaction method can provide more active sites for conducting lithium ion so as to significantly lower interface resistance. Since lithium nitride has highest lithium ion conductivity within all inorganic lithium salts, it can not only inhibit the growth of dendritic crystal, but also improve circulation efficiency. The addition of THF in electrolyte can avoid the production of H₂ and stabilize pyrrole anion. Anyhow, the preparation process for lithium nitride-pyrrole composite modification is simple, and the electrochemical properties of metal lithium anode can also be significantly improved.

Without specific explanation, all kinds of raw materials in the present invention are commercial available or prepared according to the conventional methods in the art. Unless otherwise defining or explaining, all professional and scientific terms used herein have the same meaning as that of the terms familiar to those skilled in the art. Furthermore, any method and material similar or identical with the disclosure can be used in the present invention.

Other aspects of the present invention is obvious to those skilled in the art dues to the disclosure.

The invention is to be illustrated in more details with reference to the following specific examples. However, it is to be appreciated that these examples are merely intended to exemplify the invention without limiting the scope of the invention in any way. In the following examples, if no conditions are denoted for any given testing process, either conventional conditions or conditions advised by manufacturers should be followed. All percentages and parts are based on weight unless otherwise indicated.

To further illustrate the present invention, and its substantive features and notable progress, the following Comparative Examples and Examples are illustrated for detailed explanation, but the present invention is not limited to those Examples.

### Example 1

Using metal lithium foil with the diameter of 14 mm and thickness of 1-2 mm by passing N₂ for 1 h as an electrode, polypropylene film obtained from Celgard (US) as a separation film, and 1M LiPF₆/(EC+DMC) (1:1 w/w) as electrolyte to conduct the test for change of electrochemical impedance vs. time wherein the scanning rate was 10 mV/s. The result was shown in Table 1.

### Example 2

Using metal lithium foil with the diameter of 14 mm and thickness of 1-2 mm by passing N₂ for 5 h as an electrode, polypropylene film obtained from Celgard (US) as a separation film, and 1M LiPF₆/(EC+DMC) (1:1 w/w) as electrolyte to conduct the test for change of electrochemical impedance vs. time wherein the scanning rate was 10 mV/s. The result was shown in Table 1.

### Example 3

Using metal lithium foil with the diameter of 14 mm and thickness of 1-2 mm, the surface of which was treated by THF solution for 1 min, by passing N₂ for 1 h as an electrode, polypropylene film obtained from Celgard (US) as a separation film, and 1M LiPF₆/(EC+DMC) (1:1 w/w) as electrolyte to conduct the test for change of electrochemical impedance vs. time wherein the scanning rate is 10 mV/s. The result was shown in Table 1.

### Example 4

Using metal lithium foil with the diameter of 14 mm and thickness of 1-2 mm, the surface of which was treated by THF solution for 1 min, by passing N₂ for 5 h as an electrode, polypropylene film obtained from Celgard (US) as a separation film, and 1M LiPF₆/(EC+DMC) (1:1 w/w) as electrolyte to conduct the test for change of electrochemical impedance vs. time wherein the scanning rate is 10 mV/s. The result was shown in Table 1.

### Example 5

Using metal lithium foil with the diameter of 14 mm and thickness of 1-2 mm by passing N₂ for 5 h, then treating the surface Pyrrole/by THF (1:1 v/v) solution for 1 min, as an electrode, polypropylene film obtained from Celgard (US) as a separation film, and 1M LiPF₆/(EC+DMC) (1:1 w/w) as electrolyte to conduct the test for change of electrochemical impedance vs. time wherein the scanning rate is 10 mV/s. The result was shown in Table 1.

### Example 6

Using metal lithium foil with the diameter of 14 mm and thickness of 1-2 mm by passing N₂ for 5 h, then treating the surface Pyrrole/by THF (1:10 v/v) solution for 1 min, as an electrode, polypropylene film obtained from Celgard (US) as a separation film, and 1M LiPF₆/(EC+DMC) (1:1 w/w) as electrolyte to conduct the test for change of electrochemical impedance vs. time wherein the scanning rate is 10 mV/s. The result was shown in Table 1.

TABLE 1

| | 1 h | 24 h | 48 h | 72 h |
|---|---|---|---|---|
| | (Ohm/cm²) | (Ohm/cm²) | (Ohm/cm²) | (Ohm/cm²) |
| unmodified metal | 891.4 | 1495.4 | 1777.5 | 1784.6 |
| lithium electrode | | | | |
| passing N₂ (1 h) | 235.32 | 622.06 | 683.26 | 1282.05 |
| passing N₂ (5 h) | 607.98 | 1371.7 | 905.08 | 1140.69 |
| pre-treating metal | 342.70 | 548.27 | 677.05 | 1465.63 |
| lithium by THF, | | | | |
| then passing N₂ | | | | |
| (1 h) | | | | |
| pre-treating metal | 349.49 | 616.86 | 1527.01 | 1806.09 |
| lithium by THF, | | | | |
| then passing N₂ | | | | |
| (5 h) | | | | |
| passing N₂ (1 h), | 123.86 | 107.16 | 126.71 | 115.03 |
| then pre-treating | | | | |
| Li—Li₃N by | | | | |
| THF/pyrrole(1:1 | | | | |
| v/v) mixed | | | | |
| solution | | | | |
| passing N₂ (5 h), | 225.17 | 196.29 | 349.45 | 375.45 |
| then pre-treating | | | | |
| Li—Li₃N by | | | | |
| THF/pyrrole(1:1 | | | | |
| v/v) mixed | | | | |
| solution | | | | |

As known from the data of Table 1, the composite film of Li₃N and pyrrole can effectively lower interface resistance of lithium anode/electrolyte, and stabilize the interface.

### Example 7

Using metal lithium foil with the diameter of 14 mm and thickness of 1-2 mm as an electrode, polypropylene film obtained from Celgard (US) as a separation film, and 0.5M pyrrole/electrolyte (1M LiPF₆/(EC+DMC) (1:1 w/w)) mixed solution as electrolyte to conduct the test for change of electrochemical impedance vs. time wherein the scanning rate was 10 mV/s. The result was shown in Table 2.

### Example 8

Using metal lithium foil with the diameter of 14 mm and thickness of 1-2 mm as an electrode, polypropylene film obtained from Celgard (US) as a separation film, and 1M pyrrole/electrolyte (1M LiPF₆/(EC+DMC) (1:1 w/w)) mixed solution as electrolyte to conduct the test for change of electrochemical impedance vs. time wherein the scanning rate was 10 mV/s. The result was shown in Table 2.

### Example 9

Using metal lithium foil with the diameter of 14 mm and thickness of 1-2 mm as an electrode, the surface of which was washed by tetrahydrofuran (THF) solution for 0.5-2 min, polypropylene film obtained from Celgard (US) as a separation film, and 1M LiPF₆/(EC+DMC) (1:1 w/w) solution as electrolyte to conduct the test for change of electrochemical impedance vs. time wherein the scanning rate was 10 mV/s. The result was shown in Table 2.

### Example 10

Using metal lithium foil with the diameter of 14 mm and thickness of 1-2 mm as an electrode, the surface of which was washed by tetrahydrofuran (THF) solution for 0.5-2 min, polypropylene film obtained from Celgard (US) as a separation film, and 0.1M pyrrole/electrolyte (1M LiPF₆/(EC+DMC) (1:1 w/w)) mixed solution as electrolyte to conduct the test for change of electrochemical impedance vs. time wherein the scanning rate was 10 mV/s. The result was shown in Table 2.

### Example 11

Using metal lithium foil with the diameter of 14 mm and thickness of 1-2 mm as an electrode, the surface of which was washed by tetrahydrofuran (THF) solution for 0.5-2 min, polypropylene film obtained from Celgard (US) as a separation film, and 0.5M pyrrole/electrolyte (1M LiPF₆/(EC+DMC) (1:1 w/w)) mixed solution as electrolyte to conduct the test for change of electrochemical impedance vs. time wherein the scanning rate was 10 mV/s. The result was shown in Table 2.

### Example 12

Using metal lithium foil with the diameter of 14 mm and thickness of 1-2 mm as an electrode, the surface of which was washed by tetrahydrofuran (THF) solution for 0.5-2 min, polypropylene film obtained from Celgard (US) as a separation film, and 1M pyrrole/electrolyte (1M LiPF₆/(EC+DMC) (1:1 w/w)) mixed solution as electrolyte to conduct the test for change of electrochemical impedance vs. time wherein the scanning rate was 10 mV/s. The result was shown in Table 2.

TABLE 2

| | 1 h | 24 h | 48 h | 72 h |
|---|---|---|---|---|
| | (Ohm/cm²) | (Ohm/cm²) | (Ohm/cm²) | (Ohm/cm²) |
| unmodified lithium | 140.663 | 317.104 | 399.333 | 433.593 |
| anode | | | | |
| 0.1M pyrrole modified | 227.544 | 250.363 | 105.028 | 88.084 |
| 0.5M pyrrole modified | 347.926 | 761.675 | 668.580 | 1243.130 |
| THF pre-treated lithium | 228.500 | 594.610 | 642.410 | 859.310 |
| anode | | | | |
| THF pre-treated lithium | 102.403 | 144.860 | 98.990 | 108.75 |
| anode + 0.1M pyrrole | | | | |
| modified | | | | |
| THF pre-treated lithium | 325.169 | 198.286 | 149.451 | 85.446 |
| anode + 0.5M pyrrole | | | | |
| modified | | | | |

As known from the data of Table 2, pyrrole can effectively lower interface resistance of lithium anode/electrolyte, and stabilize the interface.

The above contents merely concern preferred embodiments of the present invention, not to limit the substantive technical contents of the present invention. The substantive technical contents of the present invention are widely defined in the scope of the claims of the present application. Any other technical body or method, if completely identical with that defined in the scope of the claims of the present application, is also an equivalent change, and is regarded as covered by the scope of the claims of the present application.

All references mentioned in this disclosure are incorporated herein by reference, as if each of them would be incorporated herein by reference independently. In addition, it is to be appreciated that various changes or modifications can be made to the invention by those skilled in the art who have read the content taught above. These equivalents are intended to be included in the scope defined by the following claims of the application.

What is claimed is:

1. Protected metal anode architecture comprising:
a metal anode layer; and
an organic protection film formed over and optionally in direct contact with the metal anode layer, wherein
the metal anode layer comprises a metal selected from the group consisting of an alkaline metal and an alkaline earth metal, and
the organic protection film comprises a reaction product of the metal and an electron donor compound.

2. The protected metal anode architecture according to claim 1, wherein the metal anode layer comprises a lithium metal or a lithium metal alloy.

3. The protected metal anode architecture according to claim 1, wherein the metal anode layer comprises a lithium metal and the organic protection film comprises lithium pyrrolide.

4. The protected metal anode architecture according to claim 1, wherein the organic protection film comprises one or more of an alkylated pyrrolide, phenyl pyrrolide, alkenyl pyrrolide, hydroxy pyrrolide, carbonyl pyrrolide, carboxyl pyrrolide, nitrosylated pyrrolide and acyl pyrrolide.

5. The protected metal anode architecture according to claim 1, wherein the electron donor compound is selected from the group consisting of pyrrole, indole, carbazole, 2-acetylpyrrole, 2,5-dimethylpyrrole and thiophene.

6. The protected metal anode architecture according to claim 1, wherein the organic protection film has an average thickness of no more than 200 nm.

7. The protected metal anode architecture according to claim 1, wherein the electron donor compound has an average density of from about 20 to 95% of a theoretical density of the organic protection film.

8. The protected metal anode architecture according to claim 1, wherein the electron donor compound comprises one or more inactive additives selected from the group consisting of tetrahydrofuran, di-methyl ether, di-methyl sulfide, acetone and diethyl ketone.

9. The protected metal anode architecture according to claim 1, wherein the electron donor compound is in direct contact with the metal anode layer.

10. The protected metal anode architecture according to claim 1, further comprising an inorganic layer formed between the metal anode layer and the organic protection film.

11. The protected metal anode architecture according to claim 10, wherein the inorganic layer comprises a nitride of the metal.

12. A method of forming a protected metal anode architecture comprising:
optionally pre-treating an exposed surface of a metal anode;
exposing the metal anode to a solution comprising an electron donor compound; and
forming an organic protection film over the metal anode layer, wherein the organic protection film comprises a reaction product of the metal and the electron donor compound.

13. The method according to claim 12, wherein the pre-treating comprises exposing the metal anode to a solution comprising one or more inactive additives selected from the group consisting of tetrahydrofuran, di-methyl ether, di-methyl sulfide, acetone and diethyl ketone.

14. The method according to claim 12, wherein the pre-treating comprises forming a metal nitride layer over a surface of the metal anode.

15. The method according to claim 12, wherein the pre-treating comprises exposing a surface of the metal anode to flowing nitrogen and forming a metal nitride layer over a surface of the metal anode.

16. The method according to claim 12, wherein the electron donor compound is selected from the group consisting of pyrrole, indole, carbazole, 2-acetylpyrrole, 2,5-dimethylpyrrole and thiophene.

17. The method according to claim 12, wherein a concentration of the electron donor compound in the solution ranges from about 0.005 to 10M.

18. The method according to claim 12, wherein a concentration of the electron donor compound in the solution ranges from about 0.01 to 1M.

19. The method according to claim 12, wherein the reaction product is formed by applying a current density of from about 0.1 to 5 mA/cm² and a charge potential of from about 1 to 2V between the metal anode layer and a second electrode.

20. The method according to claim 12, wherein the reaction product is formed by applying a current density of from about 1 to 2 mA/cm² and a charge potential of from about 1 to 2V between the metal anode layer and a second electrode.
